(19) United States
(12) Patent Application Publication
(10) Pub. No.: US 2009/0246394 A1
(43) Pub. Date: Oct. 1, 2009

(54) Method for applying hydrophobic compositions to display screens

(76) Inventors: Eric L. Hanson, Carlsbad, CA (US); Bruce Jackson, Escondido, CA (US); Eric L. Bruner, San Diego, CA (US)

Correspondence Address: William J. Uhl, 4110 Devonwood Court, Murrysville, PA, 15668, US

(21) Appl. No.: 12/290,965

(22) Filed: Nov. 5, 2008

Related U.S. Application Data
(63) Continuation-in-part of application No. 12/080,054, filed on Mar. 31, 2008.

(51) Int. Cl. B05D 1/28

(52) U.S. Cl. 427/428.2; 427/429

(57) ABSTRACT

A method for applying a hydrophobic coating to a surface of a display screen is disclosed.

### CROSS REFERENCE TO RELATED APPLICATION

The present application is a continuation-in-part of U.S. application Ser. No. 12/080,054, filed Mar. 31, 2008.

### FIELD OF THE INVENTION

The present invention relates to a method for applying hydrophobic compositions to display screens, particularly small display screens such as those associated with electrooptical display devices such as cell phones and personal data assistants.

### BACKGROUND OF THE INVENTION

Electrical display devices are susceptible to dirt collection and smudging. This is particularly true if the surface is a polymeric material. Typically the surface is cleaned by spraying a cleaning solution such as a surfactant dissolved in a water-alcohol mixture and wiped with a cloth or paper towel. However, this cleaning treatment is temporary and offers no lasting protection for dirt collection or smudging.

To provide more lasting protection, it is known to apply hydrophobic coatings to optical surfaces. These coatings can be based on fluoropolymers and provide a somewhat more durable coating which typically lasts from 1 to 2 weeks depending on the hydrophobic material and on the surface being treated. Typically the hydrophobic material is applied by spraying and wiping the excess material from the surface being treated. Although this is an acceptable method for treating large surfaces such as those associated with automotive windshields, it is not particularly effective for treating smaller surfaces such as those associated with small electrooptical display devices such as cellular phones and personal data assistants. Spray applying the hydrophobic composition covers not only the display surface but also to the surrounding surfaces where it is not needed. This results in a waste of a relatively expensive composition.

Also, it is known to apply hydrophobic compositions to windshields using an applicator that comprises a housing in the shape of a deodorant bar with an applicator that dispenses the hydrophobic composition by pressing the applicator tip against the windshield surface and wiping the tip across the surface.

The present invention overcomes the above problems by providing a method for applying a hydrophobic composition to a surface of a display screen in which the composition is applied to the surface without wasteful overspray.

### SUMMARY OF THE INVENTION

The present invention provides a method of treating a display screen with a flowable hydrophobic composition using an applicator comprising a housing containing the flowable hydrophobic composition; a means for dispensing the composition, the means being fixed to the housing and the dispensing means including an applicator tip for depositing a layer of the composition on the display screen in response to contact between the applicator and the display screen. The method including the steps of:
(a) grasping the housing by hand with the applicator tip pointed towards the display screen;
(b) placing the applicator tip on the display screen;
(c) rubbing the applicator tip over the display screen so as to deposit a layer of the hydrophobic composition on the display screen; and
(d) removing the applicator tip from the display screen.

### BRIEF DESCRIPTION OF THE DRAWINGS

FIG. 1 is an elevational view of an applicator useful in the practice of the invention.

FIG. 2 is a longitudinal sectional view of an applicator useful in the practice of the invention.

FIG. 3 is an elevational view of an applicator applying the hydrophobic composition of the invention to a personal data assistant.

FIG. 4 is an elevational view of an alternate embodiment of an applicator useful in the practice of the invention.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

The term “polymer” is also meant to include oligomer and copolymer.

Referring now in detail to the drawings, the reference numeral 10 denotes generally an applicator suitable for dispensing a hydrophobic composition in accordance with the invention. The applicator 10 includes an elongate barrel shape body 12 that carries the liquid hydrophobic composition. A fiber applicator 14 is mounted at an end of the body for dispensing the hydrophobic composition. A tight-fitting cap 16 is furnished for preventing evaporation of the hydrophobic composition from the applicator 14 and for augmenting an overall appearance of the applicator in simulation of a writing instrument, for example, a pen, felt tip marker, etc.

With reference now to FIG. 2, the body 12 is formed of a generally cylindrical housing 20 which is typically fabricated of a suitable thermoplastic such as acrylonitrile-butadiene-styrene, polyvinyl chloride, polyethylene, polycarbonates, etc. which are not chemically reactive with the hydrophobic composition. Preferably, the housing is impervious to the transmission of water vapor. The housing 20 includes an elongated generally cylindrical wall extending from a lower end 30 to the dispensing end 28. From the end 28 to an opposite end 30, the housing 20 includes a hollow cylindrical bore 32.

Carried within the cylindrical bore 32 is a liquid reservoir 34 comprising a wadding 36 of fibrous liquid absorbent material, such as cotton or synthetic fibers. The wadding 36 is saturated with the hydrophobic composition. The lower end 30 of the housing 20 can be closed with a liquid tight plug 40. The applicator can be filled and refilled by removing the plug and filling with the hydrophobic composition. Alternatively, the hydrophobic composition and wadding 36 can be pre-packaged in the form of a cartridge inserted into the bore 32.

The dispensing end 28 of the housing 20 carries a fiber applicator 42. The fiber applicator 42 may be formed of conventional material such as felt comprising natural and/or synthetic fibers, e.g. cotton, polyester, polyethylene and microfiber (blend of polyester and polyamide), and includes a substantially cylindrical body 44 having a diameter substantially that of the bore 32 so that the applicator is tightly seated in the bore. Projecting upwardly from the body 44 is a wedge or chisel shaped applicator tip 48, while a cylindrical tail wick 50 projects downwardly into the wadding 36 of the reservoir 34 and is substantially surrounded by the wadding 36. The fibrous nature of the applicator 42 ensures that the liquid hydrophobic composition stored in the reservoir 34 will be drawn to the applicator tip 42 by capillary action. Alternatively or in conjunction with capillary action, pressure may be applied to the reservoir 34 to force the composition to the applicator tip 48. This may be accomplished by using a housing 20 made of a deformable thermoplastic material and pressing on the sides.

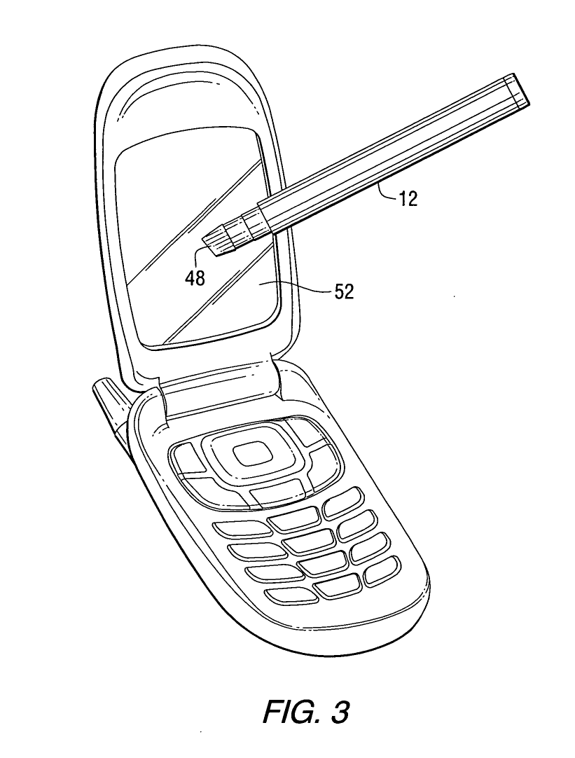

As depicted in FIG. 3, the hydrophobic composition carried in the reservoir 34 may be easily applied as a coating to an optical surface 52 by grasping the body 12, contacting the surfaces to be treated with the applicator tip 48 and wiping the tip over the surface to be treated.

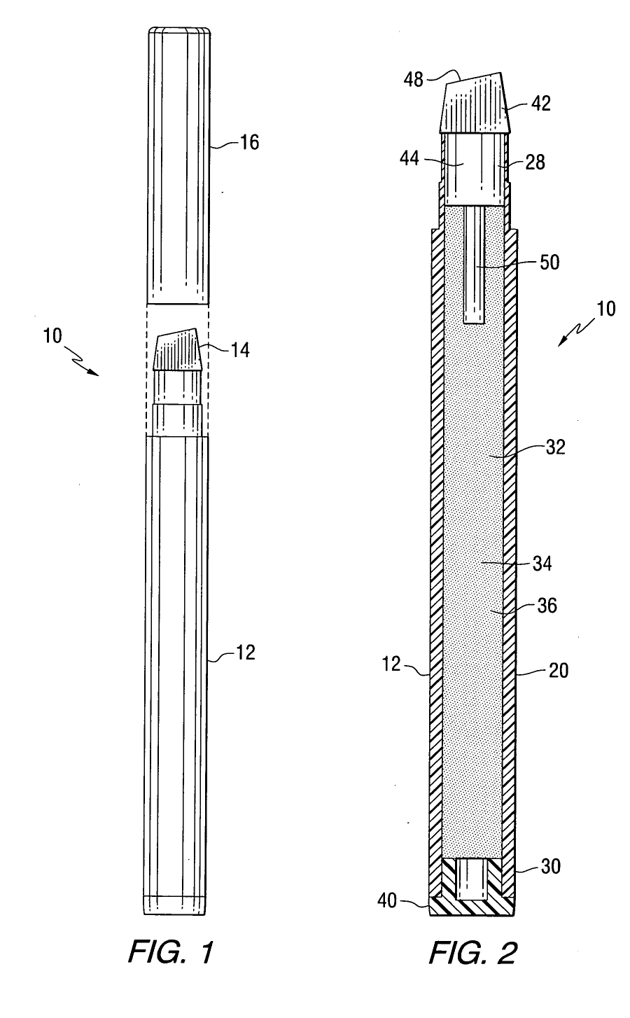

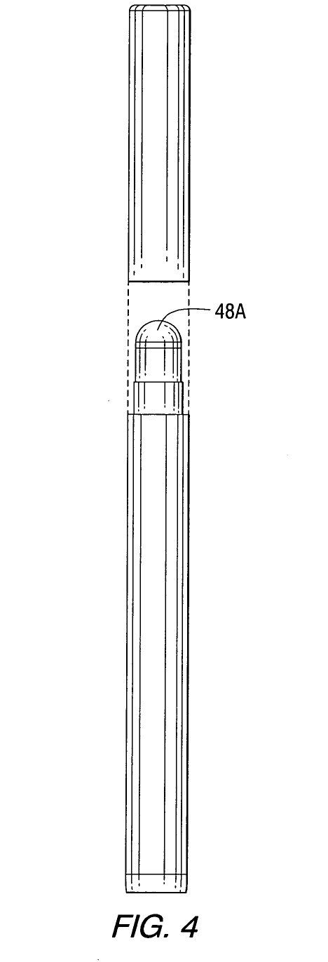

An alternate embodiment of the invention is depicted in FIG. 4. The embodiment of FIG. 4 differs from the embodiment of FIGS. 1 through 3 in that, in lieu of employing a fiber applicator, a ball roller 48A is utilized. The ball roller 48A may comprise a conventional liquid applicator mechanism such as that disclosed in U.S. Pat. Nos. 4,490,350 or 5,154,525.

The ball roller can be made of ceramic, nylon or other synthetic material that will not be affected by the hydrophobic composition. The ball roller should be at one end of the housing in such a way that approximately one-half of the roller is in contact with the hydrophobic composition (the composition without the wadding) and the other half is accessible so as to roll across the surface to be treated.

Applications such as those disclosed in U.S. Pat. No. 6,474,894 can also be used.

The surfaces or substrates to which the hydrophobic compositions are applied may be an inorganic substrate such as glass, or an organic substrate such as a polymeric substrate. The substrate is in the form of a display device. The term “display device” means a device having an exposed surface that is substantially transparent through which an underlying image is transmitted

Examples of suitable polymers for display devices are acrylonitrile butadiene-styrene copolymers, polycarbonates, polyurethanes, polyamides, polyimides, poly(amide-imide), polyepoxides, polyesters such as polyethylene terephthalate, polyethylene naphthalate, acrylic polymers and copolymers, polysiloxanes, polyolefins, polyaromatics, polyvinyl alcohol, polysaccharides and polymers derived from cellulose such as cellulose triacetate. In many cases, the polymer has reactive or strongly interacting groups at the surface, such as aromatics, amides, carbonyls, siloxanes or silanes, nitriles, unsaturated bonds, hydroxyls, etc. Preferably, the polymer surface has carbonyl, amide, hydroxyl, ether or oxide groups. Examples of display screens are electrooptical devices such as those associated with light emitting diodes, cathode ray tubes, liquid crystals and plasma screens. Applying the hydrophobic composition with the applicator as described above is useful for display screens having a viewing surface of 14,000 cm² and for small articles having a viewing surface less than 50, such as less than 15, and less than 10 cm² such as display areas associated with cellular phones and personal data assistants, MP3 players, touch screens and computer display screens and televisions. The hydrophobic compositions can be applied to such surfaces with the above-described applicator without wasteful overspray.

The hydrophobic compositions can be selected from those based on fluoropolymers and/or polysiloxanes. Preferred hydrophobic compositions are metal silicon complexes. By metal silicon complexes are meant reaction products of metals, particularly transition metals and silicon containing materials, particularly organosilanes and polysiloxanes.

The transition metal compound preferably is derived from niobium and transition metals that have electrons in the f electron orbital such as metals selected from Period 6 (lanthanide series) of the Periodic Table of elements. Examples of suitable metals include La, Hf, Ta, and W, with Ta being preferred. The ligand associated with the transition metal may be an alkoxide containing from 1 to 18, preferably 2 to 8 carbon atoms such as ethoxide, propoxide, isopropoxide, butoxide, isobutoxide and tertiary butoxide. The alkoxides may be in the form of simple esters and polymeric forms of the esters. For example, with the preferred metal Ta, the simple esters would be Ta(OR)₅ where R is C₁ to C₁₈ alkyl. Polymeric esters would be obtained by condensation of the alkyl esters mentioned above and typically would have the structure RO—[Ta(OR)₃—O—]ₓR where R is defined above and x is a positive integer. Besides alkoxides, examples of other ligands are halides, particularly chloride, acetyl acetonates, alkanolamine and lactate. Mixed ligands such as alkoxides and acetyl acetonates may also be present. TaCl₅ is a preferred transition metal compound.

Examples of silicon-containing materials are organosilicon-containing materials and organosilanes such as those having the formula:

R¹₄₋ₓSiAₓ or (R¹₃Si)_{y}B

and organo(poly)siloxanes and organo(poly)silazanes containing units of the formula:

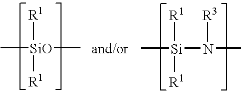

where R¹ are identical or different and are a monovalent including a substituted, such as halo, particularly fluoro-substituted hydrocarbon radical containing from 1 to 100, such as 1 to 20 carbon atoms and 1 to 6 carbon atoms. A in the above structural formula may be hydrogen, a halogen such as chloride, OH, OR² or

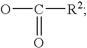

B in the above structural formula can be NR³_{3-y}. R² is a monovalent hydrocarbon or substituted hydrocarbon radical containing from 1 to 12, typically 1 to 4 carbon atoms. R³ is hydrogen or has the same meaning as R¹. x is 1, 2 or 3, y is 1 or 2.

Preferably, R¹ is a fluoro-substituted hydrocarbon. Examples of such fluoro-substituted hydrocarbons are those of the structure:

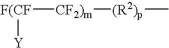

where Y is F or CₙF₂ₙ₊₁; m is 4 to 20 and n is 1 to 6; R² is alkyl containing from 1 to 4 carbon atoms and p is 0 to 18. Also, fluoro-substituted hydrocarbons may be of the structure:

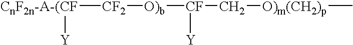

where A is an oxygen radical or a chemical bond; n is 1 to 6, y is F or Cₙ, F₂ₙ; b is at least 1, such as 2 to 10; m is 0 to 6 and p is 0 to 18.

The organosilicon material can also be an organo(poly)siloxane or an organo(poly)silazane such as those having the structural units:

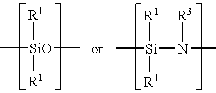

where R¹ is a hydrocarbon or substituted hydrocarbon having from 1 to 6 carbon atoms such as methyl and ethyl and R³ is hydrogen or a hydrocarbon or substituted hydrocarbon having 1 to 6 carbon atoms. The organo(poly)siloxane may contain additional units of the formula:

R⁵₂SiO₂

where R⁵ is a halogen such as a chloro or fluoro substituent.

The organo(poly)siloxane and organo(poly)silazane typically have a number average molecular weight of at least 1000, usually between 1000 and 5,000,000.

The reaction products can be prepared by mixing the transition metal compound and the silicon-containing material in a closed system (i.e., low humidity) to avoid hydrolysis of the reactants. Reaction can occur neat or in the presence of a non-reactive solvent such as chlorinated or fluorinated solvent, for example, methylene chloride. Reaction occurs rapidly at room temperature and is complete from 1 to 30 minutes depending upon the reactants. Also, once again depending upon the reactants, heat can be used to initiate and complete the reaction. Solvent can be removed by evaporation and the reaction product can be redissolved in a suitable solvent such as an alcohol, for example, ethanol or propanol, for application to the substrate. The mole ratio of the organosilicon-containing material to transition metal compound is typically from 100:1 to 1:100, preferably from 1:1 to 10:1 depending on the valence of the transition metal compound. For example, the molar ratio of organosilicon compound to Ta(V) is typically 5 to 1.

The reaction product is typically dissolved or dispersed in an organic diluent. Examples of suitable diluents are alcohols such as methanol, ethanol and propanol, aliphatic hydrocarbons such as hexane, isooctane and decane, ethers, for example, tetrahydrofuran, and dialkylethers such as diethylether, on the transition metal specie to make the resulting complex more stable.

Also, adjuvant materials may be present in the composition. Examples include stabilizers such as sterically hindered alcohols and acids or surfactants. Also, additional active agents may also be incorporated into the coating composition, such as antibacterial agents, anti-static compounds, lubricants, etc. The adjuvants if present are present in amounts of up to 30 percent by weight based on the non-volatile content of the composition.

The concentration of the reaction product in the composition is not particularly critical but is usually at least 0.01 millimolar, typically from 0.01 to 100 millimolar, and more typically from 0.1 to 50 millimolar.

The composition can be obtained by mixing all of the components at the same time with low shear mixing or by combining the ingredients in several steps. The reaction product is reactive with moisture, and care should be taken that moisture is not introduced with the diluent or adjuvant materials and that mixing is conducted in a substantially anhydrous atmosphere.

The applicator is filled with the hydrophobic composition and the composition is applied to the surface to be treated with the applicator. This is typically accomplished by grasping the housing of the applicator by hand with the applicator tip pointed toward the surface to be treated. The applicator tip is placed on the surface and rubbing the applicator tip across the surface so as to deposit a layer of the hydrophobic composition on the surface. After the layer has been applied, the applicator tip is removed from the surface and the treated surface optionally wiped with a cloth or paper towel.

The resultant layer is thin, having a thickness less than 100 nanometers, typically 2 to 50 nanometers, and is hydrophobic, having a water contact angle less than 70°, typically from 75-130°. The squalene contact angle is greater than 20°. The water contact angle and the squalene contact angle can be determined using a contact angle goniometer such as a TANTEC contact angle meter Model CAM-MICRO.

Since various possible embodiments might be made of the present invention and since various changes might be made in the exemplary embodiments set forth herein without departing from the spirit of the invention, it is to be understood that all matter herein described or shown in the accompanying drawings is to be interpreted as illustrative and not in a limiting sense.

The invention is now set forth in the following claims.

What is claimed is:

1. A method of treating a display screen with a flowable hydrophobic composition using an applicator comprising a housing containing the flowable hydrophobic composition; a means for dispensing the composition, the means being fixed to the housing and the dispensing means including an applicator tip for depositing a layer of the composition on the display screen in response to contact between the applicator and the display screen, the method including the steps of:
(a) grasping the housing by hand with the applicator tip pointed towards the display screen;
(b) placing the applicator tip on the display screen;
(c) rubbing the applicator tip over the display screen so as to deposit a layer of the hydrophobic composition on the display screen; and
(d) removing the applicator tip from the display screen.

2. The method of claim 1, which further includes wiping the treated display screen with a cloth to remove excess composition.

3. The method of claim 1 in which the display screen is selected from a polymer and glass.

4. The method of claim 3 in which the display screen is a polymer.

5. The method of claim 4 in which the polymer is selected from acrylonitrile butadiene-styrene copolymers, polycarbonate, polyurethane, polyester, acrylic polymers and copolymers, polyamides, polyimides, poly(amide-imide), polysulfones, polymers derived from polyepoxides, polysiloxanes, polyolefins, polyaromatics, polyvinyl alcohol, polysaccharides and polymers derived from cellulose.

6. The method of claim 1 in which the display screen is an electrooptical device.

7. The method of claim 6 in which the electrooptical device is that associated with a light-emitting diode, cathode ray tube, liquid crystals and plasma screens.

8. The method of claim 7 in which the electrooptical device is selected from a personal data assistant, cell phone, MP3 player, computer, touch screen, and television.

9. The method of claim 1 in which the display screen has a viewing surface less than 14000 cm².

10. The method of claim 1 in which the applicator tip has a cross-sectional area no greater than 35 cm².
